(19) United States
(12) Patent Application Publication
(10) Pub. No.: US 2026/0086740 A1
(43) Pub. Date: Mar. 26, 2026

(54) READ AHEAD INDICATION

(71) Applicant: Micron Technology, Inc., Boise, ID (US)

(72) Inventor: Binbin HUO, Sauerlach (DE)

(21) Appl. No.: 19/279,288

(22) Filed: Jul. 24, 2025

Related U.S. Application Data
(60) Provisional application No. 63/697,759, filed on Sep. 23, 2024.

(51) Int. Cl. G06F 3/06

(52) U.S. Cl. CPC G06F 3/0659; G06F 3/0604; G06F 3/0679

(57) ABSTRACT

In some implementations, a memory apparatus may receive, from a host system, a first read command indicating first data, wherein the first read command includes a read ahead indication. The memory apparatus may obtain, based on the first read command including the read ahead indication, second data from a non-volatile memory location. The memory apparatus may store the second data in a volatile memory location.

### CROSS-REFERENCE TO RELATED APPLICATION

This patent application claims priority to U.S. Provisional Patent Application No. 63/697,759, filed on Sep. 23, 2024, entitled “READ AHEAD INDICATION,” and assigned to the assignee hereof The disclosure of the prior Application is considered part of and is incorporated by reference into this patent application.

### TECHNICAL FIELD

The present disclosure generally relates to memory devices, memory device operations, and, for example, to a read ahead indication.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. A non-volatile memory device, such as a NAND memory device, may use circuitry to enable electrically programming, erasing, and storing of data even when a power source is not supplied. Non-volatile memory devices may be used in various types of electronic devices, such as computers, mobile phones, or automobile computing systems, among other examples.

A read ahead operation (sometimes referred to as a prefetch operation) in a memory device is an operation in which the memory device anticipates data that will be requested in the future (e.g., requested by a host) and preloads the data into volatile memory (e.g., a cache) before the actual read request for the data is made. A read ahead operation improves memory access times by reducing the wait periods associated with retrieving data from slower memory components, such as non-volatile memory. By performing the read ahead operation, the memory device can enhance the performance and efficiency of applications.

### BRIEF DESCRIPTION OF THE DRAWINGS

FIG. 1 is a diagram illustrating an example system capable of communicating a read ahead indication.

FIG. 2 is a diagram of an example associated with read ahead operations.

FIGS. 3A-3C are diagrams of an example associated with a read ahead indication.

FIG. 4 is a diagram of an example associated with a read ahead indication.

FIG. 5 is a flowchart of an example method associated with a read ahead indication.

FIG. 6 is a flowchart of an example method associated with a read ahead indication.

### DETAILED DESCRIPTION

In some memory systems, memory apparatuses and/or host systems may perform one or more operations to improve read performance. For example, a memory apparatus and/or a host system may perform read ahead operations. A read ahead operation performed by a memory apparatus may include the memory apparatus pre-fetching and storing data from NAND memory in a cache. For example, the memory apparatus may predict the data that the host system will request next and pre-load the data in volatile memory (e.g., a cache), thereby reducing the delay associated with obtaining the data at the time that the host system requests the data. At the host system, the read ahead operation may include anticipatory fetching of data that the host system predicts will be required soon, even before the actual read request is made by an application or user associated with the host system. Typically, the read ahead operation may be implemented within the operating system or application layer of the host system. The host system may analyze access patterns, such as sequential data reads, to anticipate future requests for data. Once identified, the host system preloads this data into a buffer or cache (e.g., by requesting the additional data from a memory apparatus before the data is actually requested or needed by an application executing on the host system), thereby reducing latency for subsequent read operations. This read ahead operation may be advantageous in scenarios with predictable access patterns, enhancing overall system performance and reducing wait times for data.

However, the memory apparatus and the host system may be unaware that the other device or system is performing a read ahead operation. For example, the read ahead operations may be performed locally (e.g., separately and independently) at the host system and the memory apparatus, respectively. This may result in one or more resource usage inefficiencies and/or increased complexity.

For example, mismatches between the read ahead performed by the memory apparatus and a read ahead operation performed by the host system can increase complexity as the memory apparatus attempts to predict read patterns independently of the activities on the host system. This complexity consumes additional processing resources of the memory apparatus and/or creates reliability issues and complicates the ability of the memory apparatus to efficiently handle multiple, potentially diverse, data streams originating from the host system. As a result of these complexities, the memory apparatus may allocate a significant amount of computational and memory resources within the memory apparatus for performing the read ahead operation, resulting in resource usage inefficiency.

Moreover, the read ahead operation performed by the memory apparatus can become ineffective. When the host system detects a sequential read pattern and initiates a read ahead operation, the host system may cause the memory apparatus to obtain the additional read-ahead data via requesting the additional read-ahead data in the read command. This may result in the memory apparatus unnecessarily pre-fetching further data from NAND memory. Additionally, this may result in the memory apparatus prefetching data that exceeds the actual requests from the host system, creating an imbalance in data management. Furthermore, if the host system completes or ends a read ahead operation or no longer requires additional read ahead data, the memory apparatus may be unaware and may continue to perform redundant read ahead operations, thereby consuming processing resources, time, and/or increasing the quantity of read operations from non-volatile memory. Further, the read ahead operation performed by the memory apparatus may be associated with a delay for initiating the read ahead operation (e.g., as compared to a time at which the host system initiates a read ahead operation). For example, the memory apparatus may analyze multiple read commands to detect that the read ahead operation should be initiated. This results in a mismatch in the timing of the read ahead operations in addition to delay associated with the memory apparatus initiating the read ahead operation.

Some implementations described herein enable a read ahead indication that is provided by a host system to a memory apparatus. The host system may detect or determine that the read ahead operation is to be performed (e.g., based on activity for one or more applications executing on the host system or operations performed via the host system). The memory apparatus may initiate a read ahead operation based on, in response to, or otherwise associated with receiving the read ahead indication. The read ahead indication may be included in a read command that requests first data. The memory apparatus may obtain (e.g., retrieve or read) second data from non-volatile memory (e.g., in addition to the first data) based on receiving the read ahead indication. The memory apparatus may store the second data in volatile memory (e.g., a cache). For example, the memory apparatus may be configured to receive a read command indicating first data from the host system, wherein the read command includes a read-ahead indication. Utilizing this indication, the memory apparatus proactively obtains second data from a memory location and stores the second data in a temporary storage location. After receiving a second read command for the second data, the memory apparatus provides the second data from the temporary storage location to the host system. In some examples, the memory apparatus may determine a size of the second data based on the first data requested by the read command.

As a result, the memory apparatus may coordinate prefetching activities with the read ahead requests from the host system. This host-commanded read ahead operation ensures that data prefetching is synchronized with the actual data consumption patterns at the host system, thereby reducing the instances of redundant read operations and resource usage inefficiency that may otherwise be associated with the memory apparatus independently performing a read ahead operation. By the host system indicating to the memory apparatus to perform or initiate the read ahead operation, the memory apparatus may perform the read ahead operation with more effective memory utilization and with reduced instances of unnecessary processing operations that would otherwise result from misaligned data management policies between the host system and the memory apparatus. Further, the memory apparatus may initiate the read ahead operation sooner because the memory apparatus does not need to analyze multiple read commands before determining that the read ahead operation is to be initiated. Rather, the memory apparatus can determine that the read ahead operation is to be performed based on receiving a single read command that includes the read ahead indication.

Additionally, by the memory apparatus performing the read ahead operation based on receiving the read ahead indication, the complexity of firmware of the memory device is reduced, because the firmware no longer has to support independent read-ahead algorithms. Consequently, the host-commanded read-ahead techniques described herein enhance data access speeds, conserve processing resources, memory resources, and/or network resources, among other examples, while also reducing operational complexity of the memory apparatus.

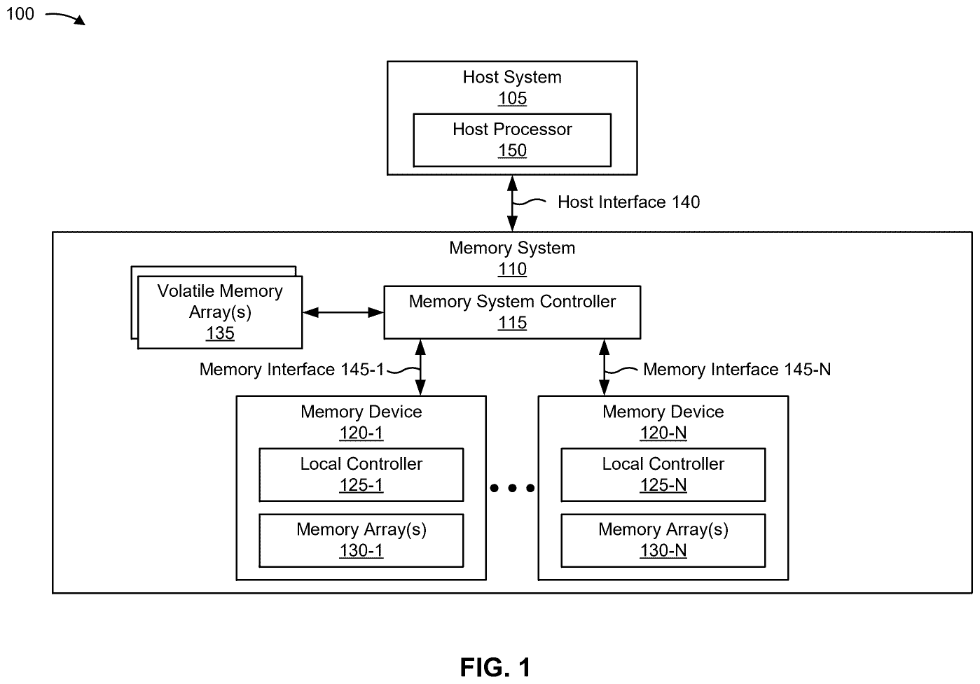

FIG. 1 is a diagram illustrating an example system 100 capable of communicating a read ahead indication. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, “memory apparatus” may refer to the memory system 110 or one or more memory devices 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system, a first read command indicating first data, wherein the first read command includes a read ahead indication; obtain, based on the first read command including the read ahead indication, second data from a memory location; store the second data in a temporary storage location; receive, from the host system, a second read command indicating the second data; and/or provide, from the temporary storage location and to the host system, the second data based on the second read command.

In some implementations, one or more systems, devices, apparatuses, components, and/or controllers of FIG. 1 may be configured to receive, from a host system, a first read command indicating first data, wherein the first read command includes a read ahead indication; obtain, based on the first read command including the read ahead indication, second data from a non-volatile memory location; and/or store the second data in a volatile memory location.

In some implementations, one or more systems, devices, apparatuses, components, and/or controllers of FIG. 1 may be configured to detect that a read ahead operation associated with a memory apparatus is to be initiated; and/or transmit, to the memory apparatus, a read command that includes a read ahead indication based on detecting that the read ahead operation is to be initiated.

In some implementations, one or more systems, devices, apparatuses, components, and/or controllers of FIG. 1 may be configured to detect that a read ahead operation associated with a memory apparatus is to be initiated; transmit, to the memory apparatus, a read command that includes a read ahead indication based on detecting that the read ahead operation is to be initiated, wherein the read command indicates first data; obtain, based on the read command including the read ahead indication, second data from a non-volatile memory location; and/or store the second data in a volatile memory location.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

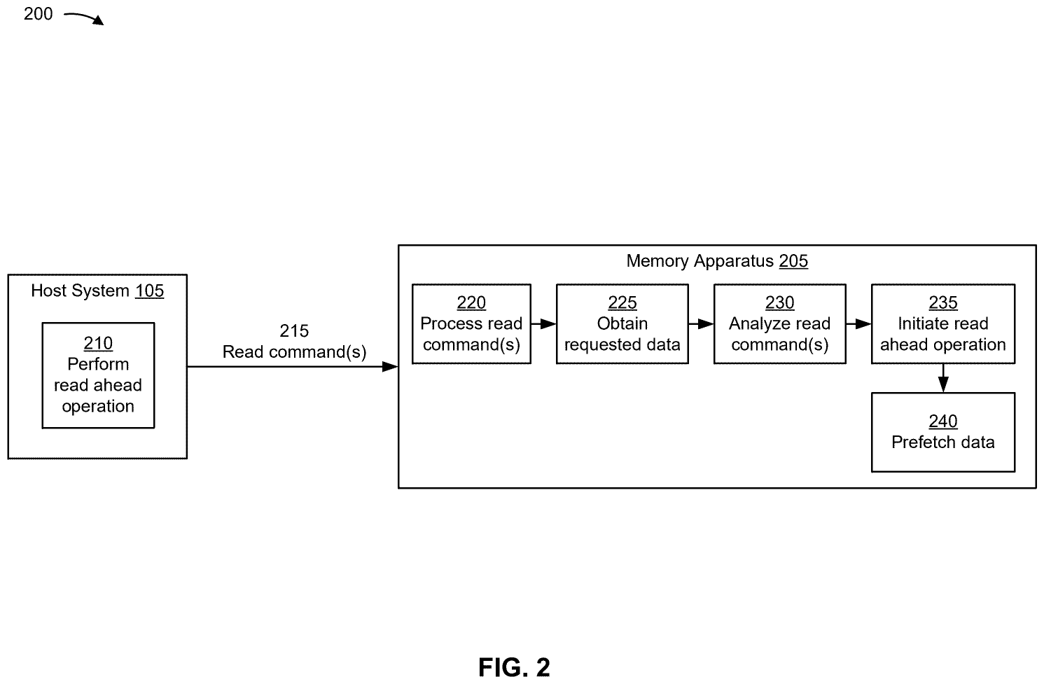

FIG. 2 is a diagram of an example 200 associated with read ahead operations. As shown in FIG. 2, example 200 includes the host system 105 and a memory apparatus 205. The memory apparatus 205 may be the memory system 110, one or more memory devices 120, the memory system controller 115, and/or a local controller 125.

As described elsewhere herein, in some examples, the host system 105 and the memory apparatus 205 may independently perform separate read ahead operations as shown in FIG. 2, resulting in resource usage inefficiency, and/or additional complexity, among other examples. For example, as shown by reference number 210, the host system 105 may perform a read ahead operation using various strategies to enhance data access efficiency and reduce latency, such as during sequential data access patterns. The host system 105 may perform the read ahead operation via a file system, an operating system, and/or one or more applications to preload data expected to be used by the host system 105 into a faster, accessible memory, such as a cache or buffer.

For example, when a file system of the host system 105 opens a large file, the host system 105 may predict that subsequent blocks of the file will be requested in a linear sequence. To optimize read performance, the host system 105 may initiate a read ahead operation as part of a data retrieval process. Upon receiving an initial read request for a certain block of a file, the host system 105 may retrieve (e.g., from the memory apparatus 205) data in addition to the requested block. For example, the host system 105 may retrieve (e.g., from the memory apparatus 205) the requested block along with one or more subsequent blocks that are likely to be needed next in association with using or reading the file. For example, if an application requests the first data block of a large file, the host system 105 may preload the next one or more data blocks into a cache. This is based on the assumption that the subsequent reads will likely follow a sequential pattern, particularly in scenarios such as streaming a video file or reading a large text document.

Additionally, or alternatively, the host system 105 may analyze incoming read requests from applications or users to identify patterns that indicate the need to perform the read ahead operation. For example, the host system 105 may monitor the sequence and frequency of read requests. For example, when an application performs a series of sequential reads over a specific range of addresses, the host system 105 may identify that pattern. In response, the host system 105 may initiate the read ahead operation to fetch additional data blocks beyond the current request in anticipation of future needs by the application or user. The host system 105 may store the additional data blocks in a cache or buffer. Should the subsequent read requests match the preloaded data block, the host system 105 can supply the data from the cache, significantly reducing access times compared to fetching each block directly from slower non-volatile memory each time that data block is requested. By preloading data, the read ahead operation shown by reference number 210 minimizes latency and reduces access times when subsequent blocks are requested by the application.

As shown in FIG. 2, the memory apparatus 205 may perform a read ahead operation independent of the read ahead operation performed by the host system 105. The memory apparatus 205 may perform the read ahead operation by proactively anticipating future data requests based on current read commands. For example, as shown by reference number 215, the host system may transmit or provide, and the memory apparatus 205 may receive or obtain, one or more read commands. In some examples, the read commands may request additional data (e.g., in addition to data requested or currently needed by an application or user of the host system 105) based on the read ahead operation performed by the host system 105. However, the read commands may only request the additional data as read data, and the memory apparatus may be unaware of the read ahead operation performed by the host system 105.

As shown by reference number 220, the memory apparatus 205 may process the one or more read commands to determine data to be read from a memory location. As shown by reference number 225, the memory apparatus 205 may obtain the requested data from the memory location. The memory location may be non-volatile memory (such as a NAND memory array) or volatile memory (such as a cache). Concurrently, as shown by reference number 230, the memory apparatus 205 may analyze patterns in the received read command(s), such as sequential access patterns, to predict the next set of data that is likely to be requested. If the memory apparatus 205 detects a pattern suggesting that additional data blocks will be requested shortly, then the memory apparatus 205 may initiate the read ahead operation, as shown by reference number 235.

As shown by reference number 240, the read ahead operation may include the memory apparatus 205 prefetching the anticipated data from non-volatile memory. The memory apparatus 205 may store the prefetched data into a faster, volatile memory location, such as a cache or a buffer. By doing so, the memory apparatus 205 may reduce the latency associated with future read operations, as the data is already loaded and readily available when the host system 105 issues subsequent read commands. However, as described in more detail elsewhere herein, the host system 105 and the memory apparatus 205 may independently and separately perform respective read ahead operations, resulting in increased complexity, inefficient resource utilization, and/or decreased effectiveness of the read ahead operation performed by the memory apparatus 205, among other examples.

As indicated above, FIG. 2 is provided as an example. Other examples may differ from what is described with regard to FIG. 2.

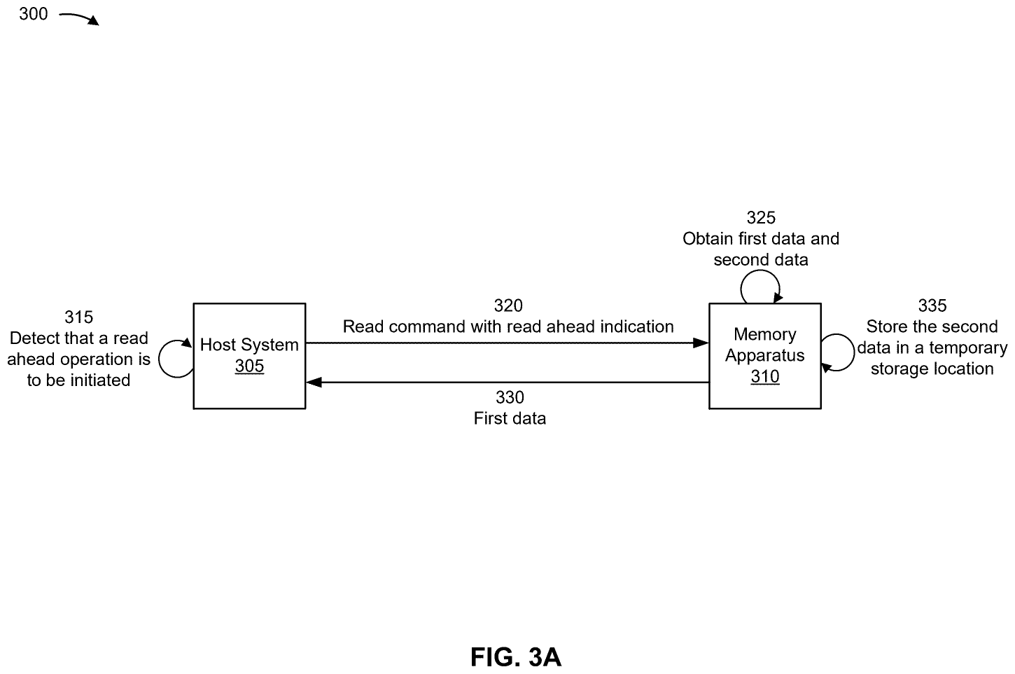

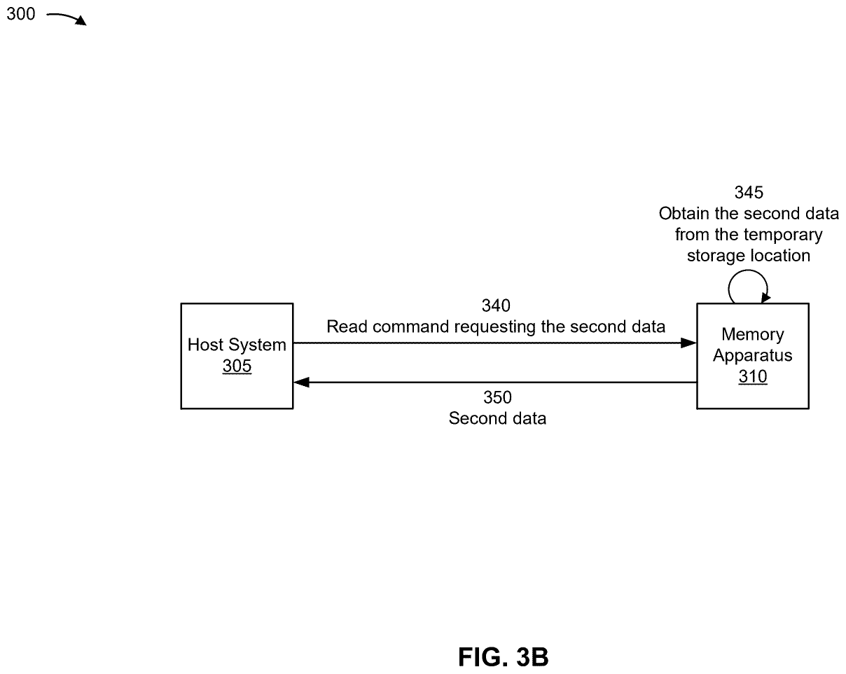

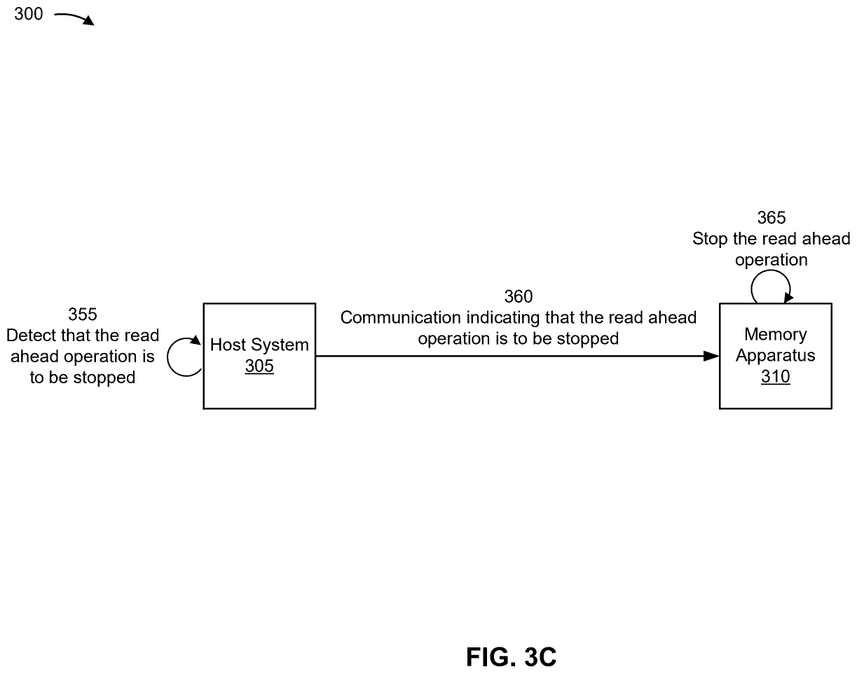

FIGS. 3A-3C are diagrams of an example 300 associated with a read ahead indication. As shown in FIGS. 3A-3C, example 300 includes a host system 305 and a memory apparatus 310. The host system 305 may be the host system 105 and/or the host processor 150. The memory apparatus 310 may be the memory system 110, one or more memory devices 120, the memory system controller 115, and/or a local controller 125.

As shown in FIG. 3A, and by reference number 315, the host system 305 may detect that a read ahead operation is to be initiated. The read ahead operation may be associated with pre-loading data by the memory apparatus 310, as described in more detail elsewhere herein. For example, the host system 305 may detect or determine that the memory apparatus 310 is to begin to perform a read ahead operation to prefetch data into a temporary storage location (e.g., volatile memory or a cache) of the memory apparatus 310 for improved data access speeds. For example, the detection and initiation of the read ahead operation may be performed by the host system 305, enabling the memory apparatus 310 to perform a read ahead operation passively (e.g., without needing to detect read operation patterns), conserving processing resources of the memory apparatus 310 and/or decreasing the complexity of read operations by the memory apparatus 310, among other examples. Additionally, because the host system 305 may have more information and/or more relevant information for upcoming read requests (e.g., because the host system 305 has more information for the systems and/or applications executing on the host system 305, which may request data that is stored by the memory apparatus 310), the host system 305 may make improved determinations as to when the read ahead operation is to be performed by the memory apparatus 310. This improves the efficiency and timing of the performance of the read ahead operation by the memory apparatus 310, as described in more detail elsewhere herein.

The host system 305 may detect that the read ahead operation is to be initiated in a similar manner as described elsewhere herein, such as in connection with FIG. 2. As an example, the host system 305 may detect that a system (e.g., a file system) or application executing on the host system 305 has opened or accessed a file (e.g., and requested a portion of data from the file, such as from the start of the file). The host system 305 may determine that logical addresses (e.g., logical block addresses (LBAs)) mapped in the file are sequential. Therefore, the host system 305 may determine that it is likely that additional data blocks associated with the file will be sequentially requested as the system or application reads, accesses, or opens the remaining portion(s) of the file. As a result, the host system 305 may detect that the read ahead operation is to be initiated to prefetch or preload the additional data blocks (or LBAs). As another example, the host system 305 may monitor a sequence of read requests from a system or application executing on the host system 305. The host system 305 may determine or identify a quantity of consecutive sequential read requests (e.g., read requests that request sequential LBAs). If the quantity of consecutive sequential read requests satisfy a threshold, then the host system 305 may detect that the read ahead operation is to be initiated to prefetch or preload additional data (e.g., because the quantity of consecutive sequential read requests satisfying the threshold may be indicative of the system or application performing a sequential read operation). The detection techniques by the host system 305 described herein are provided as examples. It should be understood that the host system 305 may detect that the read ahead operation is to be initiated in any suitable manner or using any suitable technique.

As shown by reference number 320, the host system 305 may transmit or provide, and the memory apparatus 310 may receive or obtain, a read command. The read command may request that the memory apparatus 310 retrieve first data (e.g., the read command may explicitly indicate a first set of one or more LBAs). The first data may be data that is currently needed or requested by an application or system of the host system 305. In some examples, the first data may include some additional data (e.g., to be prefetched or preloaded to be stored in a cache at the host system 305) based on the read ahead operation or detection performed by the host system 305. For example, the read command may indicate a starting LBA (or an initial LBA) and a transfer length (e.g., indicating a quantity of LBAs indicated by the read command starting from the starting LBA). The first data may include the starting LBA and a quantity of sequential LBAs after the starting LBA (e.g., where the quantity is indicated by the transfer length). In other words, the size of the first data may be indicated by the transfer length included in the read command.

Additionally, the read command may include a read ahead indication. The read ahead indication may sometimes be referred to as a read ahead hint, a read ahead request, a prefetch indication, or a preload indication, among other examples. The read ahead indication may be included in one or more fields of the read command. In some examples, the read ahead indication may be a single bit in a field of the read command (e.g., where a first binary value of the bit indicates that a read ahead indication is to be performed by the memory apparatus 310 and a second binary value of the bit indicates that the read ahead indication is not to be performed by the memory apparatus 310). In other examples, the read ahead indication may include multiple bits (e.g., for indicating additional information, as described elsewhere herein).

In some examples, based on detecting that the read ahead operation is to be initiated (e.g., as described in connection with reference number 315), the host system 305 may include the read ahead indication in the read command. In some examples, the read ahead indication may indicate that the memory apparatus 310 is to initiate a read ahead operation. In some examples, the read ahead indication includes an indication of a starting logical address (e.g., a starting LBA) of data to be prefetched or preloaded by the memory apparatus 310 as part of the read ahead indication. For example, the read ahead indication in the read command may indicate the starting LBA (or initial LBA). This enables data that is not sequential (e.g., in terms of logical addresses or LBAs) to the data indicated by the read command to be prefetched or preloaded by the memory apparatus 310.

The memory apparatus 310 may initiate the read ahead operation based on the read command including the read ahead indication. By the host system 305 providing the read ahead indication in the read command, a latency or delay associated with the memory apparatus 310 initiating the read ahead operation may be reduced because the memory apparatus 310 may initiate the read ahead operation after receiving a single read command (e.g., that includes the read ahead indication), rather than the memory apparatus 310 waiting for and/or analyzing multiple read requests to detect a pattern that indicates that the read ahead operation is to be initiated. Further, this reduces the complexity associated with determining when and/or if the read ahead operation is to be initiated by the memory apparatus 310.

As shown by reference number 325, the memory apparatus 310 may obtain first data (e.g., that is requested by the read command) and second data (e.g., as part of the read ahead operation) based on, or in response to, receiving the read command. For example, the memory apparatus 310 may determine whether the first data is stored in volatile memory (e.g., a cache, a volatile memory array 135, or a memory array 130) of the memory apparatus 310. If the first data is stored in volatile memory, then the memory apparatus 310 may obtain the first data from the volatile memory and return the first data to the host system 305 (e.g., as shown by reference number 330). If the first data is not stored in the volatile memory, then the memory apparatus 310 may prepare a read operation to read the first data from non-volatile memory (e.g., from a memory array 130).

As part of the read ahead operation, the memory apparatus 310 may obtain second data (e.g., that is not explicitly requested or indicated and/or that is not to be immediately provided to the host system 305). The second data may be referred to as read ahead data, prefetch data, or preloaded data, among other examples. The memory apparatus 310 may determine a size of the second data based on the read command. For example, the memory apparatus 310 may determine a size of the second data based on the read ahead indication. As an example, if the read command includes the read ahead indication, then the memory apparatus 310 may determine that the size of the second data is to be based on the size of the first data (e.g., that is requested by the read command). For example, the first data and the second data may have the same size. In other examples, the size of the second data may be the size of the first data modified by a factor (e.g., a scaling factor). As an example, the read command may indicate a transfer length. The memory apparatus 310 may determine or identify that a transfer length for the second data is the same as the transfer length indicated by the read command for the first data. This reduces the complexity associated with the memory apparatus 310 determining the size of the second data.

The memory apparatus 310 may determine one or more logical addresses (e.g., one or more LBAs) associated with the second data based on the read command. For example, the memory apparatus 310 may determine a starting logical address (e.g., a starting or initial LBA) for the second data and a size of the second data (e.g., as described above) to determine the one or more logical addresses (e.g., one or more LBAs). For example, the read command may indicate a transfer length and a first logical address of the first data (e.g., a starting or initial LBA of the first data). The memory apparatus 310 may determine or identify that the second data has a starting logical address that is the next logical address (e.g., sequentially in order of the logical addresses) after a last logical address of the first data. The last logical address of the first data may be indicated by the first logical address and the transfer length (e.g., the last logical address may be the first logical address plus the transfer length). As described elsewhere herein, the second data may have a size that is based on the transfer length. For example, the second data may include logical addresses starting from the next logical address (e.g., after the last logical address of the first data) plus the transfer length. In other examples, the read ahead indication may indicate the starting or initial logical address of the second data. In such examples, the second data may include logical addresses starting from the indicated starting or initial logical address plus the transfer length.

The memory apparatus 310 may obtain the second data from non-volatile memory. In some examples, such as when the first data is not stored in volatile memory or a cache of the memory apparatus 310, the memory apparatus 310 may obtain the first data and the second data from the non-volatile memory. For example, the memory apparatus 310 may perform a logical-to-physical conversion using the logical addresses of the second data (and the first data in some examples) to determine physical addresses in the non-volatile memory where the second data (and the first data in some examples) is stored. The memory apparatus 310 may obtain the second data (and the first data in some examples) from the non-volatile memory. In examples where the memory apparatus 310 obtains the first data from the non-volatile memory, the memory apparatus 310 may transmit or provide, and the host system 305 may receive or obtain, the first data (e.g., as shown by reference number 330). As shown by reference number 335, the memory apparatus 310 may store the second data in a temporary storage location (e.g., in volatile memory, in a volatile memory array, and/or in a cache).

As shown in FIG. 3B, and by reference number 340, the host system 305 may transmit or provide, and the memory apparatus 310 may receive or obtain, a read command requesting the second data. For example, the read command may explicitly request that the memory apparatus 310 return the second data to the host system 305 (e.g., the read command may include a starting logical address and a transfer length that indicates logical address(es) of the second data). As shown by reference number 345, the memory apparatus 310 may obtain the second data from the temporary storage location (e.g., from the volatile memory, the volatile memory array, or the cache). For example, as described in connection with FIG. 3A, the memory apparatus 310 may prefetch the second data as part of the read ahead operation triggered and/or initiated by the read ahead indication received by the memory apparatus 310 (e.g., as described in connection with reference number 320). As shown by reference number 350, the memory apparatus 310 may transmit or provide, and the host system 305 may receive or obtain, the second data (e.g., based on, or in response to, the read command described in connection with reference number 340).

This may improve read performance for the second data because obtaining data from volatile memory compared to non-volatile memory may be associated with faster read speeds due to the architecture of the volatile memory. For example, volatile memory stores data in a way that allows for quick random read/write access with minimal latency. In contrast, non-volatile memory often has slower access times and higher latency due to the need to manage data persistence and larger block structures. As a result, prefetching data into volatile memory reduces wait times, enhances system responsiveness, and/or improves overall performance, among other examples.

As shown in FIG. 3C, and by reference number 355, the host system 305 may detect that the read ahead operation is to be stopped. For example, the host system 305 may detect that all data for a file (e.g., that was opened and associated with sequential reads) has been obtained by the host system 305. As another example, the host system 305 may detect that the file has been closed and/or is no longer being accessed by a system or application executing on the host system 305. As another example, the host system 305 may detect that read request(s) from one or more systems or applications executing on the host system 305 are no longer sequential.

As shown by reference number 360, the host system 305 may transmit or provide, and the memory apparatus 310 may receive or obtain, a communication indicating that the read ahead operation is to be stopped or ended. In some examples, the communication may be a read command that does not include a read ahead indication. In such examples, the memory apparatus 310 may perform the read ahead operation until a read command is received that does not include another read ahead indication. In other words, the host system 305 may continue to include a read ahead indication in each read command that is provided to the memory apparatus 310 while the memory apparatus 310 is to perform the read ahead operation. After the host system 305 detects that the read ahead operation is to be stopped and/or ended, the next read command provided by the host system 305 to the memory apparatus 310 may not include a read ahead indication (e.g., to indicate to the memory apparatus 310 to stop or end the read ahead operation).

As another example, the communication may be a read command (or another command, such as an interrupt communication) that includes an indication to end the read ahead operation. For example, the read command (or other command) may include an explicit indication to stop or end the read ahead operation. In such examples, the read ahead indication (e.g., in the read command as described in connection with reference number 320) may cause the memory apparatus 310 to initiate the read ahead operation. The memory apparatus 310 may continue to perform the read ahead operation (e.g., regardless of whether subsequent read commands include a read ahead indication) in a similar manner as described herein until receiving a communication (e.g., a read command or another command) that includes the indication to end the read ahead operation.

As shown by reference number 365, the memory apparatus 310 may stop the read ahead operation. For example, the memory apparatus 310 may refrain from prefetching data and storing the prefetched data in the temporary storage location based on receiving the communication (e.g., described in connection with reference number 360).

As indicated above, FIGS. 3A-3C are provided as examples. Other examples may differ from what is described with regard to FIGS. 3A-3C.

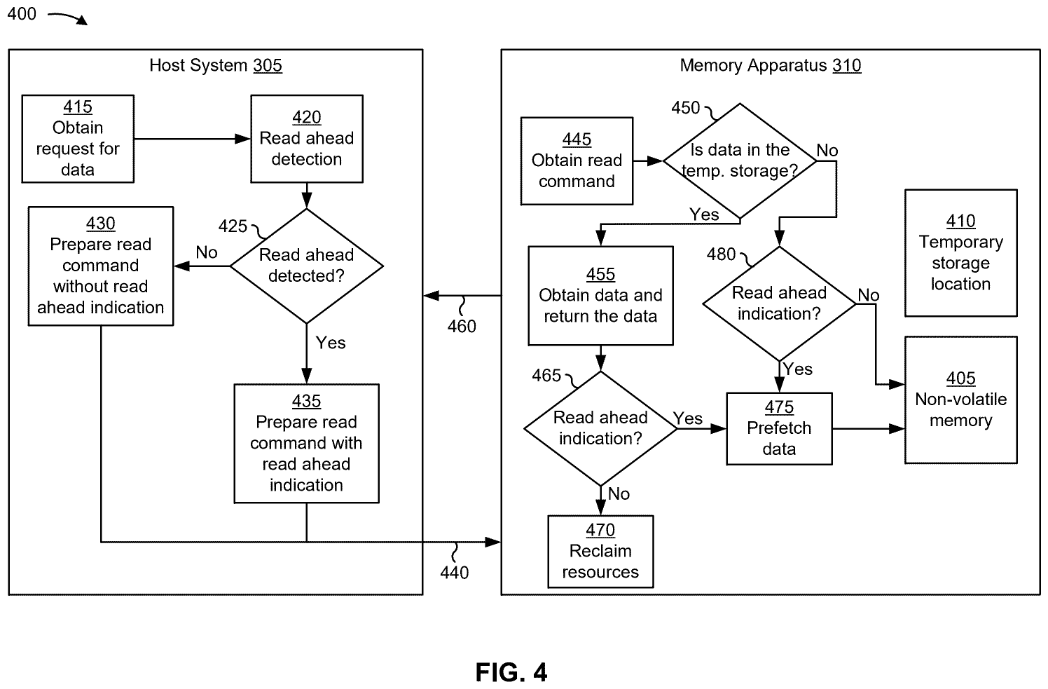

FIG. 4 is a diagram of an example 400 associated with a read ahead indication. As shown in FIG. 4, the host system 305 and the memory apparatus 310 may perform one or more operations associated with a read ahead operation. The memory apparatus 310 may include non-volatile memory 405 (e.g., one or more non-volatile memory arrays and/or one or more memory arrays 130) and a temporary storage location 410 (e.g., volatile memory, a cache, one or more volatile memory array 135, and/or one or more memory arrays 130).

As shown by reference number 415, the host system 305 may obtain a request for data (such as via a system or application executing on the host system 305). As shown by reference number 420, the host system 305 may perform read ahead detection. For example, the host system may detect whether a read ahead operation is to be performed in a similar manner as described elsewhere herein, such as in connection with reference number 315. As shown by reference number 425, the host system 305 may determine whether read ahead is detected (e.g., whether the host system 305 has detected that a read ahead operation is to be initiated). If no (or if the host system detects that an ongoing read ahead operation is to be stopped, as described in more detail elsewhere herein), then, as shown by reference number 430, the host system 305 may prepare a read command (e.g., to request data indicated by the request described in connection with reference number 415) without a read ahead indication. If yes, then, as shown by reference number 435, the host system 305 may prepare a read command e.g., to request data indicated by the request described in connection with reference number 415) with a read ahead indication. As shown by reference number 440, the host system 305 may transmit or provide the read command to the memory apparatus 310.

As shown by reference number 445, the memory apparatus 310 may obtain the read command. The memory apparatus 310 may identify data (e.g., first data) requested by the read command (e.g., based on a logical address and transfer length indicated by the read command). As shown by reference number 450, the memory apparatus 310 may determine whether the requested data is in the temporary storage location 410. If the requested data is in the temporary storage location 410, then, as shown by reference number 455, the memory apparatus 310 may obtain the data (e.g., from the temporary storage location 410) and return the requested data to the host system 305 (e.g., as shown by reference number 460). In such examples, as shown by reference number 465, the memory apparatus 310 may determine whether the read command included a read ahead indication. If the read command did not include a read ahead indication (e.g., “No” as shown in FIG. 4), then, as shown by reference number 470, the memory apparatus 310 may reclaim resources (e.g., read ahead resources). The read ahead resources may be memory resources in the temporary storage location 410 that were associated with, or reserved for, the read ahead operation. For example, the memory apparatus 310 may reclaim, based on detecting that the read ahead operation is to be stopped, memory resources in the temporary storage location 410 that are associated with the read ahead operation. The memory apparatus 310 “reclaiming” resources may refer to the memory apparatus 310 freeing up memory and computational resources that were previously allocated for the read ahead operation.

If the read command did include a read ahead indication (e.g., “Yes” as shown in FIG. 4), then, as shown by reference number 475, the memory apparatus 310 may prefetch data (e.g., second data) from the non-volatile memory 405 to be stored in the temporary storage location 410, in a similar manner as described in more detail elsewhere herein, such as in connection with FIGS. 3A-3C.

If requested data is not stored in the temporary storage location 410 (e.g., “No” from the block shown by reference number 450), then, as shown by reference number 480, the memory apparatus 310 may determine whether the read command included a read ahead indication. If the read command did not include a read ahead indication (e.g., “No” as shown in FIG. 4), then the memory apparatus may obtain the requested data from the non-volatile memory 405 and return the requested data to the host system 305 (e.g., as shown by reference number 460). If the read command did include a read ahead indication (e.g., “Yes” as shown in FIG. 4), then, as shown by reference number 475, the memory apparatus 310 may prefetch data (e.g., second data) from the non-volatile memory 405 to be stored in the temporary storage location 410, in a similar manner as described in more detail elsewhere herein, such as in connection with FIGS. 3A-3C. In such examples, the memory apparatus may obtain both the requested data (e.g., first data) and additional data (e.g., second data or read ahead data) from the non-volatile memory 405. The memory apparatus 310 may return the requested data (e.g., the first data) to the host system 305 (e.g., as shown by reference number 460). The memory apparatus 305 may store the additional data (e.g., second data or read ahead data) on the temporary storage location 410.

As indicated above, FIG. 4 is provided as an example. Other examples may differ from what is described with regard to FIG. 4.

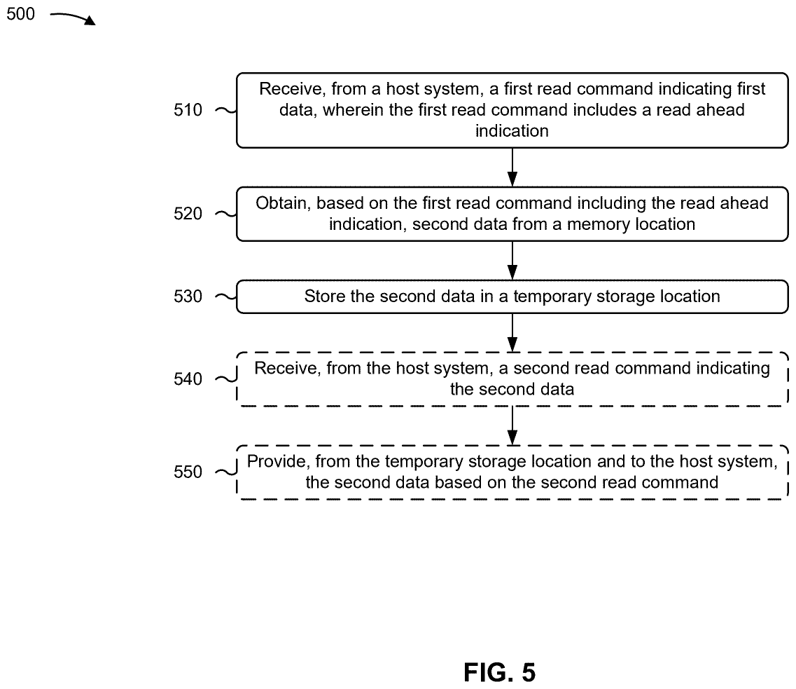

FIG. 5 is a flowchart of an example method 500 associated with a read ahead indication. In some implementations, a memory apparatus (e.g., the memory apparatus 310, the memory system 110, one or more memory devices 120, the memory system controller 115, and/or a local controller 125) may perform or may be configured to perform the method 500. In some implementations, another device or a group of devices separate from or including the memory apparatus (e.g., the host system 305, the host system 105, or the host processor 150) may perform or may be configured to perform the method 500. Additionally, or alternatively, one or more components of the memory apparatus (e.g., one or more memory devices 120, the memory system controller 115, and/or a local controller 125, a memory array 130, and/or a volatile memory array 135) may perform or may be configured to perform the method 500. Thus, means for performing the method 500 may include the memory apparatus and/or one or more components of the memory apparatus. Additionally, or alternatively, a non-transitory computer-readable medium may store one or more instructions that, when executed by the memory apparatus, cause the memory apparatus to perform the method 500.

As shown in FIG. 5, the method 500 may include receiving, from a host system, a first read command indicating first data, wherein the first read command includes a read ahead indication (block 510). As further shown in FIG. 5, the method 500 may include obtaining, based on the first read command including the read ahead indication, second data from a memory location (block 520). As further shown in FIG. 5, the method 500 may include storing the second data in a temporary storage location (block 530). As further shown in FIG. 5, the method 500 may optionally include receiving, from the host system, a second read command indicating the second data (block 540). As further shown in FIG. 5, the method 500 may optionally include providing, from the temporary storage location and to the host system, the second data based on the second read command (block 550).

The method 500 may include additional aspects, such as any single aspect or any combination of aspects described below and/or described in connection with one or more other methods or operations described elsewhere herein.

In a first aspect, the method 500 includes determining a size of the second data based on the read ahead indication.

In a second aspect, alone or in combination with the first aspect, the size of the second data is based on a size of the first data.

In a third aspect, alone or in combination with one or more of the first and second aspects, the first read command indicates a transfer length and a first logical address of the first data, wherein the second data has a starting logical address that is a next logical address after a last logical address of the first data, wherein the last logical address is indicated by the first logical address and the transfer length, and wherein the second data has a size that is based on the transfer length.

In a fourth aspect, alone or in combination with one or more of the first through third aspects, the read ahead indication includes an indication of a starting logical address of the second data.

In a fifth aspect, alone or in combination with one or more of the first through fourth aspects, the method 500 includes performing the read ahead operation until a read command is received that does not include another read ahead indication.

In a sixth aspect, alone or in combination with one or more of the first through fifth aspects, the method 500 includes receiving, from the host system, a third read command that includes an indication to end the read ahead operation, and stopping, based on the third read command including the indication to end the read ahead operation, the read ahead operation.

In a seventh aspect, alone or in combination with one or more of the first through sixth aspects, the method 500 includes detecting, after receiving the second read command, that the read ahead operation is to be stopped, and reclaiming, based on detecting that the read ahead operation is to be stopped, memory resources in the temporary storage location that are associated with the read ahead operation.

In an eighth aspect, alone or in combination with one or more of the first through seventh aspects, the read ahead indication is included in a field of the first read command.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

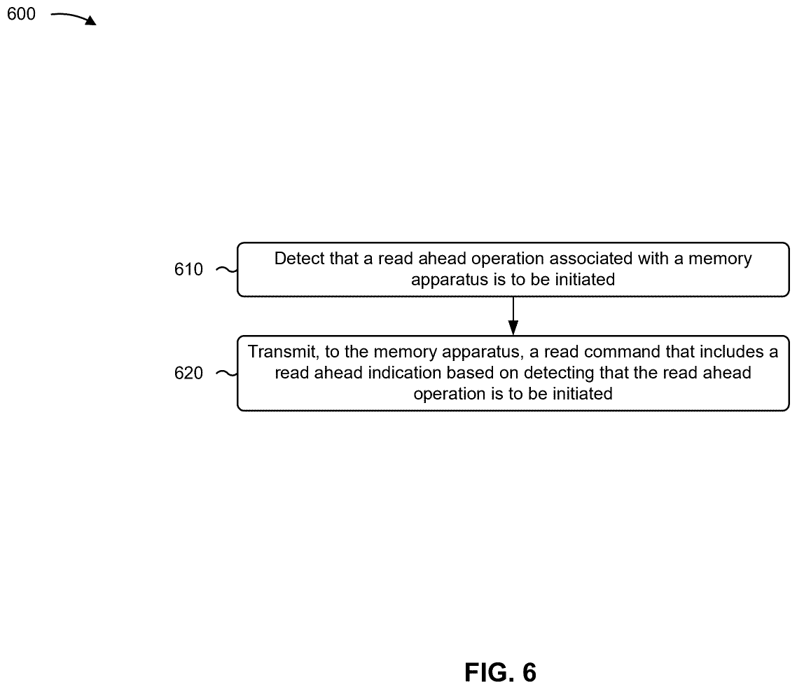

FIG. 6 is a flowchart of an example method 600 associated with a read ahead indication. In some implementations, a host system (e.g., the host system 305 and/or the host system 105) may perform or may be configured to perform the method 600. In some implementations, another device or a group of devices separate from or including the host system (e.g., the memory apparatus 310, the memory system 110, one or more memory devices 120, the memory system controller 115, and/or a local controller 125) may perform or may be configured to perform the method 600. Additionally, or alternatively, one or more components of the host system (e.g., the host processor 150) may perform or may be configured to perform the method 600. Thus, means for performing the method 600 may include the host system and/or one or more components of the host system. Additionally, or alternatively, a non-transitory computer-readable medium may store one or more instructions that, when executed by the host system, cause the host system to perform the method 600.

As shown in FIG. 6, the method 600 may include detecting that a read ahead operation associated with a memory apparatus is to be initiated (block 610). As further shown in FIG. 6, the method 600 may include transmitting, to the memory apparatus, a read command that includes a read ahead indication based on detecting that the read ahead operation is to be initiated (block 620).

The method 600 may include additional aspects, such as any single aspect or any combination of aspects described below and/or described in connection with one or more other methods or operations described elsewhere herein.

In a first aspect, the read command indicates first data, and the read ahead indication indicates that second data is to be stored in a cache of the memory apparatus.

In a second aspect, alone or in combination with the first aspect, the first data has a first size, and a second size of the second data is based on the first size.

In a third aspect, alone or in combination with one or more of the first and second aspects, the read command indicates a transfer length and a last logical address of first data requested by the read command, wherein the read ahead indication indicates second data that has a starting logical address that is a next logical address after the last logical address of the first data, and wherein the second data has a size that is based on the transfer length.

In a fourth aspect, alone or in combination with one or more of the first through third aspects, the read command indicates first data, and the read ahead indication includes an indication of a starting logical address of second data to be stored in a cache by the memory apparatus.

In a fifth aspect, alone or in combination with one or more of the first through fourth aspects, the method 600 includes detecting that the read ahead operation is to be stopped, and transmitting, to the memory apparatus, a communication that indicates that the read ahead operation is to be stopped.

In a sixth aspect, alone or in combination with one or more of the first through fifth aspects, the communication is another read command that includes an indication to stop the read ahead operation, or does not include another read ahead indication.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a memory apparatus includes one or more components configured to: receive, from a host system, a first read command indicating first data, wherein the first read command includes a read ahead indication; obtain, based on the first read command including the read ahead indication, second data from a memory location; store the second data in a temporary storage location; receive, from the host system, a second read command indicating the second data; and provide, from the temporary storage location and to the host system, the second data based on the second read command.

In some implementations, a method includes receiving, by a memory apparatus and from a host system, a first read command indicating first data, wherein the first read command includes a read ahead indication; obtaining, by the memory apparatus and based on the first read command including the read ahead indication, second data from a non-volatile memory location; and storing, by the memory apparatus, the second data in a volatile memory location.

In some implementations, a host system includes one or more components, configured to: detect that a read ahead operation associated with a memory apparatus is to be initiated; and transmit, to the memory apparatus, a read command that includes a read ahead indication based on detecting that the read ahead operation is to be initiated.

In some implementations, a system includes a host system, configured to: detect that a read ahead operation associated with a memory apparatus is to be initiated; and transmit, to the memory apparatus, a read command that includes a read ahead indication based on detecting that the read ahead operation is to be initiated, wherein the read command indicates first data; and the memory apparatus, configured to: obtain, based on the read command including the read ahead indication, second data from a non-volatile memory location; and store the second data in a volatile memory location.

In some implementations, a non-transitory computer-readable medium storing a set of instructions includes one or more instructions that, when executed by one or more processors of a memory apparatus, cause the memory apparatus to: receive, from a host system, a first read command indicating first data, wherein the first read command includes a read ahead indication; obtain, based on the first read command including the read ahead indication, second data from a non-volatile memory location; and store the second data in a volatile memory location.

In some implementations, a non-transitory computer-readable medium storing a set of instructions includes one or more instructions that, when executed by one or more processors of a host system, cause the host system to: detect that a read ahead operation associated with a memory apparatus is to be initiated; and transmit, to the memory apparatus, a read command that includes a read ahead indication based on detecting that the read ahead operation is to be initiated.

In some implementations, an apparatus includes means for receiving, from a host system, a first read command indicating first data, wherein the first read command includes a read ahead indication; means for obtaining, based on the first read command including the read ahead indication, second data from a non-volatile memory location; and means for storing the second data in a volatile memory location.

In some implementations, an apparatus includes means for detecting that a read ahead operation associated with a memory apparatus is to be initiated; and means for transmitting, to the memory apparatus, a read command that includes a read ahead indication based on detecting that the read ahead operation is to be initiated.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory apparatus, comprising:
one or more components configured to:
receive, from a host system, a first read command indicating first data, wherein the first read command includes a read ahead indication;
obtain, based on the first read command including the read ahead indication, second data from a memory location;
store the second data in a temporary storage location;
receive, from the host system, a second read command indicating the second data; and
provide, from the temporary storage location and to the host system, the second data based on the second read command.

2. The memory apparatus of claim 1, wherein the one or more components are further configured to:
determine a size of the second data based on the read ahead indication.

3. The memory apparatus of claim 2, wherein the size of the second data is based on a size of the first data.

4. The memory apparatus of claim 1, wherein the first read command indicates a transfer length and a first logical address of the first data,
wherein the second data has a starting logical address that is a next logical address after a last logical address of the first data, wherein the last logical address is indicated by the first logical address and the transfer length, and
wherein the second data has a size that is based on the transfer length.

5. The memory apparatus of claim 1, wherein the read ahead indication includes an indication of a starting logical address of the second data.

6. The memory apparatus of claim 1, wherein the first read command is configured to cause the memory apparatus to initiate a read ahead operation associated with pre-loading data, including the second data, into the temporary storage location, and wherein the one or more components are further configured to:
perform the read ahead operation until a read command is received that does not include another read ahead indication.

7. The memory apparatus of claim 1, wherein the first read command is configured to cause the memory apparatus to initiate a read ahead operation associated with pre-loading data, including the second data, into the temporary storage location, and wherein the one or more components are further configured to:
receive, from the host system, a third read command that includes an indication to end the read ahead operation; and
stop, based on the third read command including the indication to end the read ahead operation, the read ahead operation.

8. The memory apparatus of claim 1, wherein the first read command is configured to cause the memory apparatus to initiate a read ahead operation, and wherein the one or more components are further configured to:
detect, after receiving the second read command, that the read ahead operation is to be stopped; and
reclaim, based on detecting that the read ahead operation is to be stopped, memory resources in the temporary storage location that are associated with the read ahead operation.

9. The memory apparatus of claim 1, wherein the read ahead indication is included in a field of the first read command.

10. A method, comprising:
receiving, by a memory apparatus and from a host system, a first read command indicating first data, wherein the first read command includes a read ahead indication;
obtaining, by the memory apparatus and based on the first read command including the read ahead indication, second data from a non-volatile memory location; and
storing, by the memory apparatus, the second data in a volatile memory location.

11. The method of claim 10, further comprising:
receiving, from the host system, a second read command indicating the second data; and
providing, from the volatile memory location and to the host system, the second data based on the second read command.

12. The method of claim 10, wherein the first data and the second data have a same size.

13. The method of claim 10, wherein the first read command indicates a last logical address of the first data, and
wherein the second data has a starting logical address that is a next logical address after the last logical address of the first data.

14. The method of claim 10, wherein the read ahead indication includes an indication of a starting logical address of the second data.

15. The method of claim 10, further comprising:
initiating, based on the first read command including the read ahead indication, a read ahead operation; and
performing the read ahead operation until a read command is received that does not include another read ahead indication.

16. The method of claim 10, further comprising:
initiating, based on the first read command including the read ahead indication, a read ahead operation; and
receiving a second read command that includes an indication to end the read ahead operation; and
stopping, based on the second read command including the indication to end the read ahead operation, the read ahead operation.

17. A host system, comprising:
one or more components, configured to:
detect that a read ahead operation associated with a memory apparatus is to be initiated; and
transmit, to the memory apparatus, a read command that includes a read ahead indication based on detecting that the read ahead operation is to be initiated.

18. The host system of claim 17, wherein the read command indicates first data, and
wherein the read ahead indication indicates that second data is to be stored in a cache of the memory apparatus.

19. The host system of claim 18, wherein the first data has a first size, and wherein a second size of the second data is based on the first size.

20. The host system of claim 17, wherein the read command indicates a transfer length and a last logical address of first data requested by the read command,
wherein the read ahead indication indicates second data that has a starting logical address that is a next logical address after the last logical address of the first data, and
wherein the second data has a size that is based on the transfer length.

21. The host system of claim 17, wherein the read command indicates first data, and
wherein the read ahead indication includes an indication of a starting logical address of second data to be stored in a cache by the memory apparatus.

22. The host system of claim 17, wherein the one or more components are further configured to:
detect that the read ahead operation is to be stopped; and
transmit, to the memory apparatus, a communication that indicates that the read ahead operation is to be stopped.

23. The host system of claim 22, wherein the communication is another read command that:
includes an indication to stop the read ahead operation, or
does not include another read ahead indication.

24. A system, comprising:
a host system, configured to:
detect that a read ahead operation associated with a memory apparatus is to be initiated; and
transmit, to the memory apparatus, a read command that includes a read ahead indication based on detecting that the read ahead operation is to be initiated, wherein the read command indicates first data; and
the memory apparatus, configured to:
obtain, based on the read command including the read ahead indication, second data from a non-volatile memory location; and
store the second data in a volatile memory location.

25. The system of claim 24, wherein a size of the second data and a starting logical address of the second data is based on the first data.
